(19) United States
(12) Patent Application Publication
(10) Pub. No.: US 2013/0080883 A1
(43) Pub. Date: Mar. 28, 2013

(54) Patent Specification Development

(71) Applicant: Arun Kishore Narasani, Los Altos, CA (US)

(72) Inventor: Arun Kishore Narasani, Los Altos, CA (US)

(21) Appl. No.: 13/239,387

(22) Filed: Sep. 22, 2011

(51) Int. Cl. G06F 17/00

(52) U.S. Cl. 715/255

(57) ABSTRACT

The embodiments herein disclose methods and systems for patent specification development with integrated workflow and template rule management that enable real-time review and development of patent specifications in an efficient manner. Embodiments herein achieve real-time review and development of a patent specification by allowing a patent specification to be an aggregation of individual units that can be developed independently and reviewed without having to wait for a whole patent specification document to be ready. During creation of a project, the system allows for creation of rules for defining the workflow of any project. Users are allowed to predefine workflow rules and at the time of creating a project, user may choose a workflow rule to be applied to the project. The user may also create template rules and workflows based on plurality of criteria.

### TECHNICAL FIELD

The embodiments herein relate to development of patent specification documents and, more particularly, to development of patent specifications with integrated workflow and template rule management.

### BACKGROUND

A patent application is an application to be submitted by inventors or applicants to obtain protection for an invention.

A patent application includes a specification which describes the invention in a detailed manner. Writing a patent specification often requires domain expertise in a particular field of technology and also the legal expertise to ensure that the right protection is obtained. Therefore, preparing a patent specification is an intensive process that usually involves multiple people in an organization.

Preparing a patent specification is mostly a distributed process. IP law firms or service firms that prepare patent specifications for their clients usually have a hierarchy of people within one or more teams working on a single specification. Over the last few years, it has also become common practice for companies and firms to outsource part or whole of the work involved in preparing a patent specification outside of their organization to improve efficiencies and/or cut costs. Even in the case where part of the work or whole of the work involved in preparing a patent specification is outsourced, there is usually one or more responsible people within the organization that monitor the development of the patent specification and ensure the quality of the output is upto the standards of the organization. As a result, the process becomes even more complex to manage.

There are many challenges that arise in the process of preparing a patent specification.

### Preparation Process

Preparation of a patent application typically begins with a client submitting what is known as an invention disclosure form. The invention disclosure form captures the details of the invention along with other important information to make relevant decisions like claiming priority, date by which the application must be filed and so on. A team of analysts or attorneys or a combination of both usually reviews the information and in most cases has a discussion with the inventors to understand the invention in detail. Once the team is satisfied that they understand the invention well, they proceed with the preparation of the specification using the information available in the invention disclosure format and/or any notes taken during the discussions. Preparing the patent application typically starts with a senior attorney making a plan for the patent application by way of writing the outline for a broad set of claims and the list of drawings that must be included to support the claims. Such broad outline is usually written keeping in view any guidelines that may be followed by the client or by the firm preparing the application internally. Based on the broad outline of independent claims and drawings, junior attorneys or analysts prepare the drawings and description that adequately support the independent claims and drawings. Subsequently, the senior attorney may review the document, make corrections, suggest changes and develop the claims further to include dependent claims and/or improve the existing claims. The patent specification may go through a few iterations before it is considered ready for submission.

However, in some instances many attorneys change the process of development of application depending on the complexity of an invention, the urgency of the matter, availability of resources and so on. For example, when an invention is very complex or something that the senior attorney does not understand to the fullest extent, he may choose to get the description prepared first without giving the outline of claims of drawings just to spend more time on the invention. In some cases, when a case has to be filed immediately within a few hours or within a day or two, the senior attorney may decide to have different sections of an application written simultaneously without following a rigorous review process.

Therefore, the process to be followed can change depending on the situation and managing the process that potentially varies across multiple projects happening at the same may become complex.

### Guidelines and Templates

Different attorneys follow different guidelines in preparing a patent specification. The guidelines an attorney follows depends on the interpretation of the law by the attorney. Sometimes guidelines followed by an attorney is also a matter of style and choice. In some other instances, there may be guidelines provided by clients on how to prepare applications prepared for the clients. Guidelines may include standard disclaimer texts, kind of words to use, kind of words to avoid and so on. Further, the guidelines may vary depending on the country in which the application is being filed. Furthermore, guidelines also vary based on the subject matter covered in an application.

The attorney in charge of an application must ensure the right guideline is used for preparing an application. To ensure that the right guideline is used and the right disclaimers are used, firms have a number of templates that are specific to clients, countries, subject matter, types of applications and so on. Managing the different templates and ensuring that the right template is used for a particular application is a complicated and error prone process.

### Distributed Nature of Work

Since, in many instances, different attorneys/analysts write different sections, review becomes a tedious process. When a junior attorney takes up a specification for writing the description, his understanding of the invention or the breadth of the invention may not be same as the understanding of the attorney that gave the outline through the broad set of claims and a list of drawings. Review may be done in parts or a single review may be done when the whole description is written. The kind of review process to be adopted depends on the experience of the junior attorney working on the application. When the whole description reviewed is at once, if there is a fundamental difference in understanding, then the whole document must be re-written or corrected. To avoid that, the senior attorney may have to do a review for every few drawings, especially when a junior attorney without much experience is involved. Review of partial specification may be required when the subject matter being dealt with is complex. However, such a partial review mechanism is difficult to implement in reality.

Therefore, there is a need to change the review process depending on the complexity of the application or the level of understanding of the subject matter. With existing mechanisms, managing the review process to be followed for review becomes tedious.

There are no known solutions that can be used to aid the process of preparation of a patent specification that address the aforementioned complexities in the process.

### BRIEF DESCRIPTION OF THE FIGURES

The embodiments herein will be better understood from the following detailed description with reference to the drawings, in which:

FIG. 1 illustrates patent development system, according to embodiments herein;

FIG. 2 illustrates architecture of a patent development system, according to embodiments herein;

FIG. 3 is a flow diagram depicting the process of defining a template rule, according to embodiments herein;

FIG. 4 is a flow diagram defining a workflow for patent specification development process, according to embodiments herein;

FIG. 5 is a flow diagram depicting the process flow involved in patent specification development, according to embodiments herein;

FIG. 6 is a flow diagram depicting dynamic review process in patent specification development, according to embodiments herein; and

FIG. 7 is a flow diagram depicting notification of events, according to embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

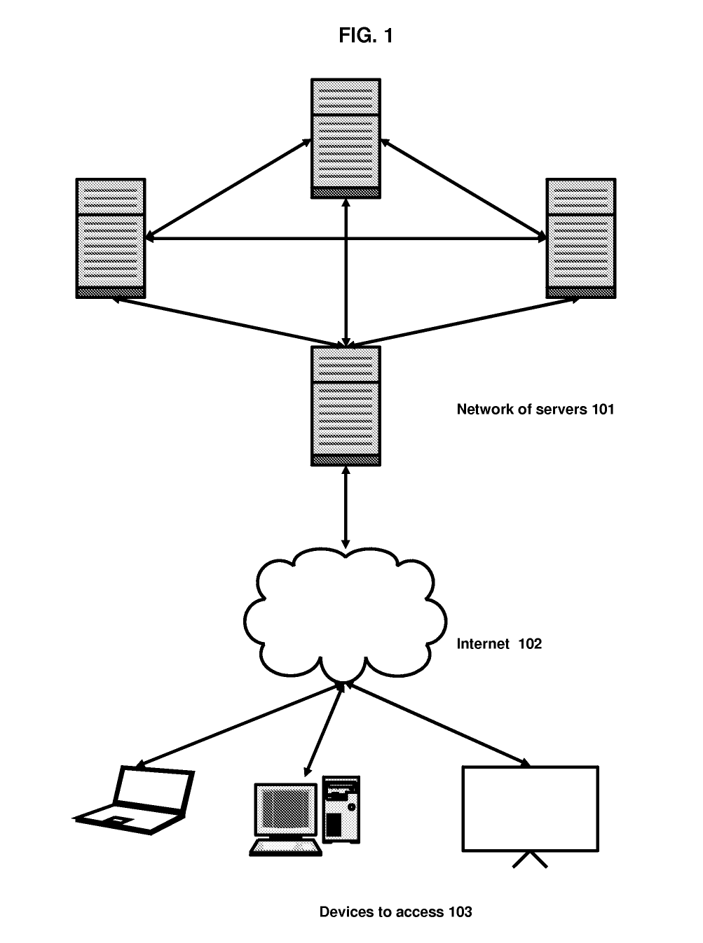

The embodiments herein disclose methods and systems for patent specification development with integrated workflow and template rule management that enable real-time review and development of patent specifications in an efficient manner. Preferred embodiments herein achieve real-time review and development of a patent specification by allowing a patent specification to be an aggregation of individual units that can be developed independently and reviewed without having to wait for a whole patent specification document to be ready. Referring now to the drawings, and more particularly to FIGS. 1 through 7, where similar reference characters denote corresponding features consistently throughout the figures, there are shown embodiments.

Systems and methods for development of patent specification are disclosed. The method employs integrated workflow and template management mechanisms. The method enables the user to independently develop various sections of the patent specification and dynamically monitor the progress of the patent specification. In addition, the user may also perform reviews on the fly. Users can create projects for creating patent specifications. In a preferred embodiment, one project has one patent specification associated with it. However, in some embodiments, one project may have multiple patent specifications associated with it.

The system allows for creation of rules for defining the workflow of the project. Users are allowed to predefine workflow rules. In an example, a user may create workflows specific to particular clients or type of clients. At the time of creating a project, user may choose an already defined workflow rule to be applied to the project. The user may further define roles and reminders associated with various activities defined in the selected workflow.

Further, the system allows for creation of template rules to be associated with a particular project or a specification. User may create template rules and associate such template rules to a project or a specification within a project. At the time of creating a project, user may choose an existing template rule to be applied to the project.

FIG. 1 illustrates a patent specification development system, according to embodiments herein. As depicted the system, in a preferred embodiment, comprises of a network of servers 101, the internet 102 and plurality of devices 103. The network of servers 101 store on them the software and algorithms configured for the patent specification development. The servers 101 store and process patent specification template rules, rule codes, work flows, details on notifications and remainders. Further, user configured details regarding the project, workflow and the like are also stored on the server 101. The servers 101 may be of different nature. In a preferred embodiment, at least one of the servers 101 is a database server, and at least one of the servers 101 hosts as application server to run one or more applications to enable the various methods as disclosed herein. In various embodiments, a network of database servers and a network of application servers are hosted on the network of servers 101 to enable the various methods disclosed herein.

The servers 101 are connected to the user through the internet 102. The internet acts as a medium for interaction between the user and the applications hosted on the servers 101 for patent specification development.

The devices 103 provide access to the patent specification development applications delivered by the servers 101. The devices 103 allow a user to interact with the applications. The devices 103 may include laptops, desktops, personal computers and the like.

In a preferred embodiment, users may access the applications hosted on the servers 101 through a web browser using HTTP protocol. The applications hosted on the servers 101 deliver content in a format that can be rendered by a web browser. However, in various embodiments, the system may also be implemented in using other commonly known alternatives to deliver content to user devices. Such alternatives include but are not limited to web services model using SOAP, RMI and so on.

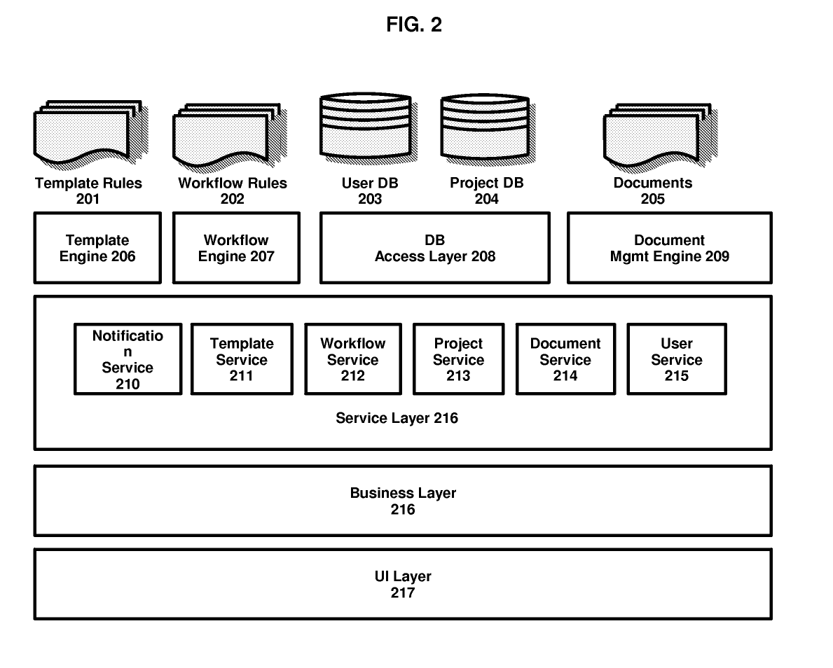

FIG. 2 illustrates architecture of a patent specification development application, according to embodiments herein. As depicted in the figure the patent development application architecture comprises of several sub modules that assist in the patent development process. The sub modules include template rules 201, workflow rules 202, user database 203, project database 204, documents 205, template engine 206, workflow engine 207, database access layer 208, document management engine 209, notification service 210, template service 211, workflow service 212, project service 213, document service 214, user service 215, business layer 217 and User Interface (UI) layer 218.

Template rules 201 define the rules that are specific for each specification template. For example, if the patent specification is for a US provisional filing then the rules corresponding to US provisional may be applied. A template rule defines the sections to be included, their hierarchy, a default text to be included, the order of sections and so on.

Template rules may be defined/chosen depending on the type of application, based on client definitions, or based on subject matter. For example, if a patent specification is for a client who has a specific set of rules or guidelines on what kind of sections to be included and the related default text within those sections, then a specific template rule for the client may be created so that the template rule may be chosen at the time of creation of a project for such a patent specification 201.

In an embodiment, a template rule 201 may be selected a default template rule to be applied when a user does not select any template rule at the time of creating a new project. In some embodiments, the default template rule can be pre-selected for the user at the time of creating a project. Further, the user may override such selection if he chooses to apply another template rule or create a new template rule.

The workflow rules 202 specify the workflow pattern as configured by the user. The workflow pattern may be selected based on several factors that include urgency of the project, availability of content and so on. Workflow rules 202 allow the user to define the process and assign the process that is appropriate to a particular project at the time of creating the project. User may be allowed to choose from a list of available workflow steps in defining a workflow. In an example workflow steps may include the following: Plan development, Plan review, Section development, Section Review—Level 1, Section Review—Level 2, Final doc review—Level 1, Final doc review—Level 2, Client Review and so on.

The user database 203 stores the details configured by the user. The details may be information on the user credentials, user preferences including project/workflow/template rule specific preferences, workflow/template rule selections, projects involved, work allocation details, notification details, alerts configured and so on.

The project database 204 store details related to a project. The details may be name of the projects, sections, users involved in handling the project, sections allocated to each user, client details, and timelines and so on.

The documents 205 may store different documents that may be required by the user for access. These may be some guidelines, template rules, or any reference documents uploaded by individual users.

The template engine 206 provides access to the template rules 201. The template engine 206 interacts with the user based on the choice made by the user and fetches the rules from the template rules 201 to be applied for a project during the execution of the project.

The workflow engine 207 provides access to the workflow rules 202 and fetches the rules as and when required, during the execution of a project.

The database access layer 208 provides access to both the user database 203 and project database 204. User database 203 is contacted when details relevant to a user are required and project database 204 is contacted when details relevant to the project are required.

The document management engine 209 interacts with the document module 205 in order to fetch documents or portions of documents when required.

The service layer 216 comprises of a number of service components. The service layer supports exposing the services through various mechanisms. The service components may be deployes as in application server components or as remote components depending the architecture. In various embodiments, the system can also be deployed in a distributed architecture where multiple layers are residing physically in different servers in a network. In a remote component based architecture, the various services may be accessed using web service model among other possible models.

The notification service 210 is responsible for storing details on notifications. The details may include configurations of notification, the mode of receiving notifications, notifications sent and received, status of notifications, and so on.

The template service 211 is responsible for handling template rule details. The template service interacts with the template engine to provide various useful services. The workflow service 212 addresses services related to the workflow defined for a project. The project service 213 addresses services related to projects on the system. The document service 214 addresses services related to documents and interact with the document management engine 209. User service 215 interacts with information relating to a user and provides various related services.

The business layer 217 hosts the business logic relating to but not limited to interactions between various services available on the system, and aggregation of services and delivery of aggregated information to provide relevant information as requested by a user by interfacing with various services available.

The User Interface (UI) 218 layer provides for delivering content in the format as required by a user. In a preferred embodiment, the UI layer 218 may support multiple types of user interfaces. For example, in a HTTP based web system, the UI module 218 can support sending data in multiple formats including but not limited to HTML, XML and so on.

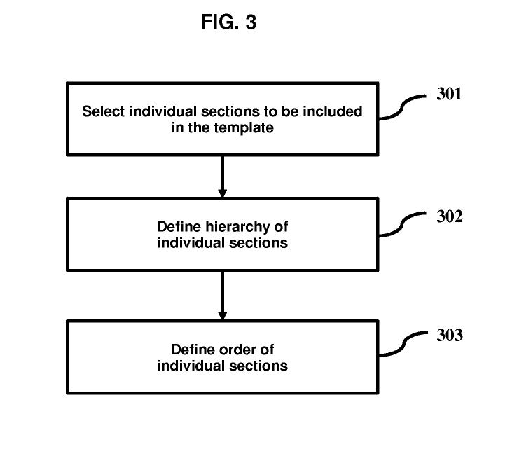

FIG. 3 is a flow diagram depicting the process of defining a template rule, according to embodiments herein. A user on the system can create a template rule before creating a project or at the time of creating a project. The definition of a template rule involves selecting (301) individual sections to be included in the specification template. In a preferred embodiment, the system provides a comprehensive list of sections to choose from. The user will also be able to add new sections based on specific needs. Definition of a section may include at least specifying whether it is a description section or a drawing section, the title of the section, any beginning or ending text that is to be included as a standard text for the section, whether the new section is a sub-section of an existing section. Upon selecting a list of sections either from an existing list or by creating new sections or a combination of both, the user can define (302) hierarchy of the sections selected. Further, the user can select (303) the order in which sections may appear.

In various embodiments, the individual sections are decided based on the type of template rule chosen for creation of the patent specification. For example, if the patent specification is for US filing then the template rule corresponding to US requirements is chosen. In another embodiment, the template rule may be specific to the clients also. In such a case, if a client X has specific template requirements specified for preparing a US provisional specification, then the patent specification template rule for the client X will be chosen for preparing such an application.

As an example, the various sections for a US provisional are shown in the tables below. The various sections include background, field, prior art, summary, general disclaimers, detailed description, beginning disclaimer, embodiment context, drawing description, drawing specific embodiment disclaimer, ending disclaimer, claims with description, claims, abstract, relevant figure and drawing. When the user selects the template rule the system provides different sections to be present in the patent specification. The system then provides appropriate titles for the section using definition information. Each template rule is assigned a rule code. A rule code may be a unique code chosen to represent a template rule. The system provides facility to store multiple template rules for a single type of application, for example a US provisional application. Each template rule will have a unique rule code as an identifier for the template rule. The user may choose a particular template rule as a default template rule for a US provisional template.

A template rule is identified by a rule code. When a user selects a template rule, the user is effectively choosing a rule code. Based on the rule code associated with the template rule chosen by a user, the system obtains information relating to the sections that are part of the rule code and then constructs the specification using such information.

Rule codes may be defined based on the type of application, the client name and so on. In an example, table 1 shows definition of sections associated with three different template rules: default US provisional template rule represented by rule code “US_PV_default”, US provisional template rule for “client 1” represented by “US_PV_client_{—}1”, and default PCT specification template rule represented by the rule code “PCT_default”. The table shows the definition of each section for each rule code. The table further defines the display title for each section, the field to capture the text at the start of a particular section using “starts with”, and the field to capture the text at the end of a particular section using “ends with”. The field “title” captures the display title. When a display title is not provided for a section, the system may use the section name as the display title for that section. The fields ‘starts with’ and ‘ends with’ are employed in order to capture any default text to be used a the start of a section and at the end of a section respectively. The table shows only rules representing three template rules for simplicity. The table can contain rules for hundreds of different rules. Similarly, for simplicity, all sections are part of all rules. In various embodiments, sections can be part of only one or a subset of all rules present.

The user can choose to define the order for a particular rule code as per the requirements of the patent specification associated with the template rule. Table 2 represents the definition of order of sections for rule code US_PV_default as an example. In table, sections are defined in the order in which should appear in a default US provisional specification for which no template rule is selected. The hierarchy of sections to be include in the default US provisional can be defined by specifying the H-Level value. A top level section is given the value “0” and a sub-section of a top level section will be given the value “1”, and a sub-section of a sub-section of a top level section will be given the value “2” and so on. The field “Multiple” captures the information on whether a section repeats multiple times. And, the field “Included” captures the information on whether a section is part of the template rule. This example assumes that all sections are listed for all rule codes. In some embodiments, the field “Included” may not be necessary to be defined when only required sections are specified in hierarchy definition.

In an embodiment, a template rule may be selected a default template rule to be applied when a user does not select any template rule at the time of creating a new project. In some embodiments, the default template rule can be pre-selected for the user at the time of creating a project. Further, the user may override such selection if he chooses to apply another template rule or create a new template rule. The various actions in method 300 may be performed in the order presented, in a different order or simultaneously. Further, in some embodiments, some actions listed in FIG. 3 may be omitted.

TABLE 1

| | | | | |
|---|---|---|---|---|
| | | | Starts | Ends |
| Section | Title | Rule Code | with | with |

| | | |
|---|---|---|
| Background | Background | US-PV- |
| | | default |
| | | US-PV- |
| | | client_1 |
| | | PCT_default |
| Field | Technical | US-PV- |
| | Field | default |
| | | US-PV- |
| | | client_1 |
| | | PCT_default |
| Prior Art | Related Art | US-PV- |
| | | default |
| | | US-PV- |
| | | client_1 |
| | | PCT_default |
| Summary | Summary | US-PV- |
| | | default |
| | | US-PV- |
| | | client_1 |
| | | PCT_default |
| General | | US-PV- |
| disclaimer | | default |
| | | US-PV- |
| | | client_1 |
| | | PCT_default |
| Detailed | Description of | US-PV- |
| Description | Embodiments | default |
| | | US-PV- |
| | | client_1 |
| | | PCT_default |
| Beginning | | US-PV- |
| Disclaimer | | default |
| | | US-PV- |
| | | client_1 |
| | | PCT_default |
| Embodiment | | US-PV- |
| context | | default |
| | | US-PV- |
| | | client_1 |
| | | PCT_default |
| Drawing | | US-PV- |
| Description | | default |
| | | US-PV- |
| | | client_1 |
| | | PCT_default |
| Drawing | | US-PV- |
| specific | | default |
| embodiment | | US-PV- |
| disclaimer | | client_1 |
| | | PCT_default |
| Ending | | US-PV- |
| Disclaimer | | default |
| | | US-PV- |
| | | client_1 |
| | | PCT_default |
| Claims with | Preferred | US-PV- |
| description | Embodiments | default |
| | | US-PV- |
| | | client_1 |
| | | PCT_default |
| Claims | Claims | US-PV- |
| | | default |
| | | US-PV- |
| | | client_1 |
| | | PCT_default |
| Abstract | Abstract | US-PV- |
| | | default |
| | | US-PV- |
| | | client_1 |
| | | PCT_default |
| Relevant | Relevant | US-PV- |
| Figure | Figure | default |
| | | US-PV- |
| | | client_1 |
| | | PCT_default |
| Drawing | | US-PV- |
| | | default |
| | | US-PV- |
| | | client_1 |
| | | PCT_default |

TABLE 2

| Section | H-Level | Multiple | Included |
|---|---|---|---|
| Background | 0 | | Y |
| Field | 1 | | Y |
| Prior Art | 1 | | N |
| Summary | 0 | | N |
| General | 1 | | Y |
| disclaimer | | | |
| Detailed | 0 | | Y |
| Description | | | |
| Beginning | 1 | | |
| Disclaimer | | | |
| Embodiment | 1 | | |
| context | | | |
| Drawing | 1 | Y | Y |
| Description | | | |
| Drawing | 2 | | |
| specific | | | |
| embodiment | | | |
| disclaimer | | | |
| Ending | 1 | | |
| Disclaimer | | | |
| Claims with | 1 | | Y |
| description | | | |
| Claims | 0 | Y | N |
| Abstract | 0 | | Y |
| Relevant | 1 | | |
| Figure | | | |
| Drawing | 0 | Y | Y |

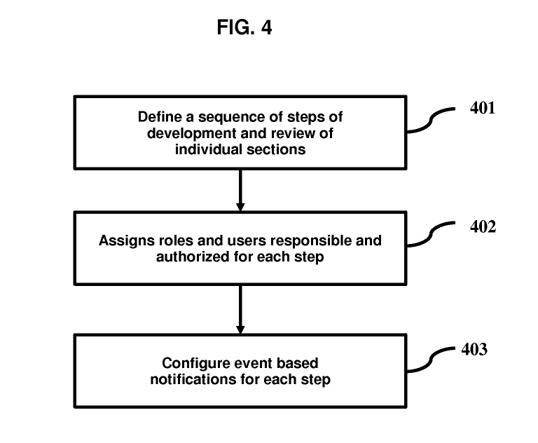

FIG. 4 is a flow diagram defining a workflow for patent specification development process, according to embodiments herein. In an example, a senior attorney may create a project for the patent specification development and define a workflow for developing the specification associated with the project. The attorney defines (401) a sequence of steps for the development of the patent specification that constitutes a workflow. The sequence of steps may specify the order of sections to be taken up for the development of the patent specification. For example, the attorney may define that background, drawings and claims to be taken up first and in the specified order. Further, the attorney may also specify review on individual sections. He may define which sections will be taken up for review first and also the time lines for completion of individual sections. Further, the attorney may assign (402) each section for individuals in the team (who may be analysts or junior attorneys), either based on rules or by identifying specific users. For example, the senior attorney may assign drawings, description and background to analysts, and claims and summary to another senior analysts. Hence, when an analyst logins in with the system, the system provides access to only those sections that are assigned to the analyst role or to the specific analyst. If a section is assigned to the analyst role in general, an analyst that first claims the section will be assigned the section for further development. The analyst is provided access to edit, modify the sections that are only assigned to him.

Further, the attorney may also configure (403) notifications for each event. For example, the attorney may configure an alert to notify him if a section is completed by the analyst or if a section is taken up by the analyst or if a deadline for a particular section is approaching and so on. The various actions in method 400 may be performed in the order presented, in a different order or simultaneously. Further, in some embodiments, some actions listed in FIG. 4 may be omitted.

In an embodiment, a workflow is a combination of different workflow steps either in sequential order or done in parallel. Some of the steps within the workflow may be in sequential order and some other steps may be allowed to be done in parallel. In a preferred embodiment, users take up their tasks by way of executing the steps in the workflow after getting their reminders, as each workflow has a role or user assigned to the step, and there are reminders for each step for specific events.

In a preferred embodiment, a workflow may be selected a default workflow to be applied when a user does not select any workflow at the time of creating a new project. In some embodiments, the default workflow can be pre-selected for the user at the time of creating a project. User may override such selection if he chooses to apply another workflow or create a new workflow.

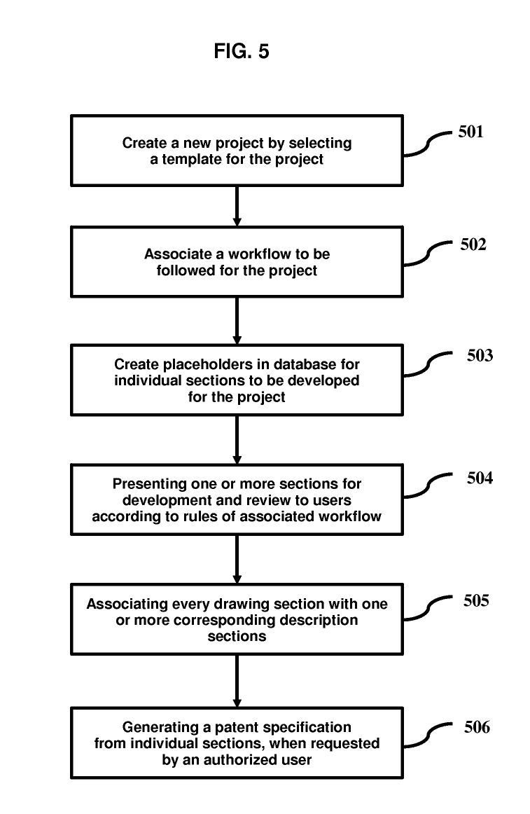

FIG. 5 is a flow diagram depicting the process flow involved in patent specification development, according to embodiments herein. The user who wants to create a patent specification selects a new project, the system then creates (501) an entry of this new project. The user also selects the template rule required for the patent specification for the new project. The user selects (502) the workflow to be associated for the new project. For example, for one project a senior attorney may choose to do the planning first by creating an outline of claims and/or drawings. In another project, the senior attorney may choose to instruct his attorneys or engineers to work on description first before working on the claims. Workflow rules allow the user to define the process and assign the process that is appropriate to a particular project at the time of starting the project. User may be allowed to choose from a list of available workflow steps. In an example workflow steps may include the following: Plan development, Plan review, Section development, Section Review—Level 1, Section Review—Level 2, Final doc review—Level 1, Final doc review—Level 2 and so on. The system then creates (503) a placeholder in the database by way of creating new entries to store data for individual sections to be developed. Individual sections may be stored on the projects database as they are assigned to different attorneys. Further, any updates or edits performed on the individual sections may be stored in the same database. The system then presents (504) one or more sections to individual users who are provided access to the sections as defined in the workflow. The sections may be presented for development of the section or may be for review. In an example, if for a workflow the rule is defined as background, drawings and claims development to be taken up first followed by detailed description, the user is provided access to the section in the same order. The system also takes care of dependency or linkages of one section on the other. Examples for linkages include but are not limited to associating (505) drawing section with one or more description sections and so on. Such linkages may be determined by taking user input. For example, when a user is working on a drawing section, user may be asked to provide relevant description sections that are related to the drawing section being worked upon. Similarly, system may also take input on relevant drawing sections when a user is working on a description section. This allows showing the relevant text section when a reviewer clicks on a drawing created and vice versa. The system also keeps track of linkages between claims and supporting material. For example, if the reviewing attorney would like to know whether there is adequate support for a claim, the reviewer may be shown the relevant portions in the description that acts as the supporting material. The reviewer can immediately check whether there is sufficient supporting material or not. The linkages may be achieved by system taking input from the section developer on the relevant figures (by way of drawing identifier) and claims (by way of claim identifier) for each section. In a preferred embodiment, the claim identifier may be different from the claim number. That way even if the number of a claim changes, the linkages remain proper. In some embodiments, the claim identifier may be same as the claim number.

In some embodiments, the drawing identifier may be the drawing number or drawing slide number. In a preferred embodiment, it may be different from the drawing number or drawing slide number. Based on the following the system may generate (506) the required patent specification from individual sections when requested by an authorized user. The various actions in method 500 may be performed in the order presented, in a different order or simultaneously. Further, in some embodiments, some actions listed in FIG. 5 may be omitted.

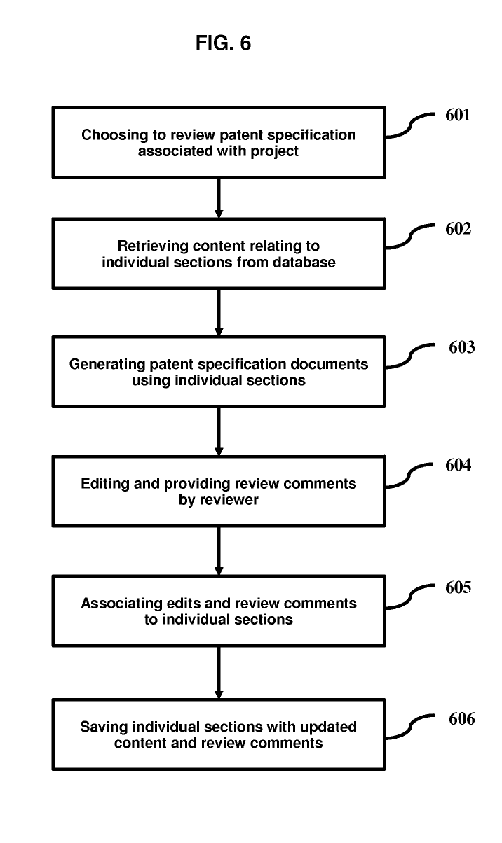

FIG. 6 is a flow diagram depicting dynamic review process in patent specification development, according to embodiments herein. The system allows performing reviews on the fly and independently for each section. The reviewer chooses (601) the project for which he would like to perform a review on the patent specification. The contents related to the project are retrieved (602) from the database. In an embodiment, the reviewer may also choose to review sections developed by individual users. In an example, if the reviewer chooses a project and the section that are completed for the corresponding project are claims, drawings, background then those sections will be displayed to the user. Further, the individual sections are put together as defined in the patent template and displayed (603) to the reviewer in accordance with template rule associated with the project. The reviewer then performs edits, introduces comments on the reviewed sections. The system enables associating (604) comments and edits to specific sections.

Further, individual sections are saved (605) by the system with updated content and review comments on the database. In a preferred embodiment, the system maintains all versions of a section independently, and allows users to roll back to a previous version. In a preferred embodiment, such rolling back to a previous version may be done only after obtaining authorization from a designated authorized user.

In some embodiments, a user may choose the review only a section independently while the section is being developed in a collaborative mode. In such a collaborative mode, the reviewing user and the user working on the section can work on the section simultaneously. Both users can enter comments for the section and such comments will be associated with the sections.

When constructing a whole patent specification from individual sections, the system can support multiple text based document formats for description including but not limited to MICROSOFT WORD, PDF and OPEN DOCUMENT formats. For drawings, the system can support multiple drawing formats including but not limited to MICROSOFT PPT, PDF, and OPEN DOCUMENT formats

The various actions in method 600 may be performed in the order presented, in a different order or simultaneously. Further, in some embodiments, some actions listed in FIG. 6 may be omitted.

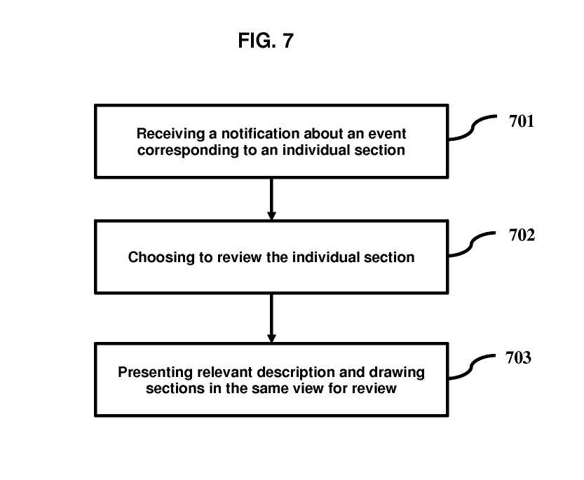

FIG. 7 is a flow diagram depicting notification of events, according to embodiments herein. In an embodiment, the user may configure to receive notifications as per his choice. Notifications allow a user responsible for a section to have the knowledge about the activity regarding the section and take immediate action. For example, a reminder may be sent when a section of interest is complete. The attorney responsible for the section may immediately have a look at the section and review the section without any delay. The notification may be configured (701) as event based for an individual section. In this case, the user may be notified when an analyst takes up that particular section for development or when the section is stated as completed and the like. For example, if the notification is configured to be received when claims are completed, then a notification may be sent when claims are completed. The notification may be in the form of an e-mail, an SMS, chat message, instant messenger with messages stored in the database. The user may then choose (702) to conduct reviews on individual sections. Once the choice is made by the user, the system presents (703) relevant sections and drawings in the same order for his review. The system allows for collaborative review of a section while the section is being written by an attorney or an analyst. For example, when an analyst is writing a section, the attorney responsible for the portion may choose to review the section while the section is being developed. Such a review mechanism may be followed when a specification document is to be completed within a short period of time.

The various actions in method 700 may be performed in the order presented, in a different order or simultaneously. Further, in some embodiments, some actions listed in FIG. 7 may be omitted.

In an embodiment, the user can also specify for each step, the roles/users that may be able to perform the step, the reminders for the step, and people to whom the reminders should be sent to associated with the step. Example reminders include: Upon starting step, Upon making changes to the step related entries and Upon closing the step.

In various embodiments, user can select one or more of the steps in sequential order or in parallel.

In an embodiment, as part of creation of the project, user may provide input on the type of patent specification by selecting a pre-defined template rule with a pre-defined code. Or user may also choose to create a new rule code, define associated set of sections for that code, and define any template rule based on the new rule code.

As part of defining associated set of sections for a new rule code, user may choose to clone one or more or all existing sections from a existing rule code and edit those sections to customize the sections for the newly defined rule code.

As part of defining template rule for a new rule code, user may choose to clone an existing template rule and edit the rule to create a new template rule for the new rule code.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

I claim:

1. A method of developing a patent specification using a computerized system, said method comprising:
creating a new project by selecting a template rule from pre-defined template rules;
associating a workflow to said project by selecting a workflow from pre-defined workflows;
creating placeholders in database for individual sections for said project based on said template rule selected;
providing access to one or more sections for development to authorized users according to said associated workflow;
presenting one or more sections for review to authorized users according to said workflow; and
generating a patent specification from said individual sections by said system, when requested by an authorized user.

2. The method as in claim 1, wherein defining a workflow comprises
defining sequence of steps for at least developing and reviewing individual sections in said project;
associating roles and users with developing an individual section or a group of individual sections from among said individual sections in said project; and
defining notification alerts for one or more events associated with developing an individual section.

3. The method as in claim 1, wherein an individual section is one among:
background, field, prior art, summary, general disclaimers, detailed description, beginning disclaimer, embodiment context, drawing description, drawing specific embodiment disclaimer, ending disclaimer, claims with description, claims, abstract, relevant figure and drawing.

4. The method as in claim 1, said method comprising associating a drawing section with corresponding one or more description sections using custom tags.

5. The method as in claim 1, said method comprising associating a claim section with corresponding one or more description sections using custom tags.

6. The method as in claim 1, said method comprising:
defining a one or more workflows for developing said patent specification; and
defining one or more template rules using at least a group of individual sections,
order of individual sections, and hierarchy of individual sections,
before creating said project.

7. The method as in claim 1, said method comprising:
defining one or more sections; and
creating a new template rule using said one or more defined sections,
before creating said project.

8. A method of enabling reviewing of a patent specification by a reviewer using a computerized system, said method comprising
choosing to review at least a portion of said patent specification associated with a project by said reviewer;
retrieving content relating to individual sections associated with said portion of said project from a database by said system;
generating said portion of said patent specification from said individual sections by said system;
providing means to edit and input review comments for said portion of said patent specification by said reviewer; and
associating edits and review comments to corresponding individual sections.

9. The method as in claim 8, wherein an individual section is one among
background, field, prior art, summary, general disclaimers, detailed description, beginning disclaimer, embodiment context, drawing description, drawing specific embodiment disclaimer, ending disclaimer, claims with description, claims, abstract, relevant figure and drawing.

10. The method as in claim 8, wherein generating a portion of said patent specification comprises
generating description document from relevant individual description sections; and
generating drawings document from relevant individual drawing sections,
when said reviewer selects to review the whole of said patent specification.

11. The method as in claim 10, wherein said method comprising presenting said description document and said drawings document in a same view adjacent to each other.

12. The method as in claim 8, wherein said method comprising highlighting one or more of individual drawing sections, individual claims sections, and individual description sections in a same view when an individual section is selected.

13. The method as in claim 8, wherein said method comprising opening associated one or more of individual drawing sections, individual claims sections, and individual description sections in a same view when an individual section is opened.

14. The method as in claim 8, wherein said review of patent specification is done collaboratively while one or more sections involved are being edited by other authorized users.

15. A method of reviewing an individual section of a patent specification project using a computerized system, said method comprising:
receiving a notification about an event corresponding to said individual section from said system by an authorized reviewer;
choosing to review said individual section by said reviewer; and
presenting said individual section to said reviewer by said system along with one or more of associated individual drawing section, individual description section, and individual claim section.

16. The method as in claim 15, wherein said event is one among
opening of said individual section;
modifying contents of said individual section;
closing of said individual section; and
marking of said individual section as completed.

17. The method as in claim 15, wherein said individual section is still being developed by authorized developer user while the reviewer is reviewing the contents of said individual section.
